(19) United States
(12) Patent Application Publication
(10) Pub. No.: US 2006/0073928 A1
(43) Pub. Date: Apr. 6, 2006

(54) Pulley, particularly for use in internal combustion engines, method for removing a pulley, and, an internal combustion engine

(76) Inventor: Edilson Oliveira, Sao Paulo (BR)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(21) Appl. No.: 11/242,349

(22) Filed: Oct. 3, 2005

(30) Foreign Application Priority Data
Oct. 4, 2004 (BR) P10404353-7

(51) Int. Cl. F16H 55/36

(52) U.S. Cl. 474/166; 474/187

(57) ABSTRACT

A pulley (1) is described, particularly used for the transmission of circular movements in internal combustion engines, featuring a set of additional orifices (3) to make possible the positioning of a tool (8) for its removal, as well as it also refers to a method to remove pulley (1) by means of a tool (8) with pins or similar projecting elements (8′) and an internal combustion engine equipped with the pulley (1).

The present invention refers to a pulley, particularly used for the transmission of circular movements in internal combustion engines, having a set of additional orifices to make possible the positioning of a tool for its removal, and it also refers to a method for the removal of the pulley by means of a tool with pins or similar projecting elements (thus allowing easy access and avoiding damages to the systems surrounding the pulley), and an internal combustion engine equipped with the pulley presently described.

### DESCRIPTION OF THE PRIOR ART

Due to the difficulty of having access with tools to carry out the removal of the water pump pulley, belonging to the internal combustion engine cooling system of any automotive vehicle (or another peripheral component as alternators, air conditioning compressors, power steering hydraulic pumps, etc.), the removal of this component, during the necessary maintenance services, becomes expensive and time consuming. Not rarely, it is necessary to use several tools and, in many cases, the removal of other components essential for the engine operation, such as radiators (requiring the draining of the cooling system fluid), coolers of the intercooler type, among others, what brings about even more expenses and increases the time spent in maintenance.

Particularly, when describing the cooling system of an automotive vehicle, it should be initially mentioned that it is composed by (i) radiator (in which the hot water, that had taken the heat from the engine components away, is cooled by air); (ii) fan (that when rotating produces a forced air flow through the radiator fins and tubes, cooling them); (iii) water compartments in the engine block and head (where the cooling fluid—usually a mixture of water and anti-boiling and/or anti-freezing additives circulates; (iv) water pump indirectly driven by the crankshaft; and (v) water hoses that conduct the circulation of water among the engine water compartments and the radiator, among other less essential components.

The process of removing the cooling system water pump of a conventional automotive vehicle consists, in most cases, of the following steps:

1. Radiator Removal

To carry out this first step, it is necessary to disconnect the water hoses, electric connectors, transmission and steering oil piping, if any, among other tasks. This step is long and delicate because some of the components may be damaged during the disassembly. Moreover, the fluids (cooling fluid, transmission oil, etc.) are lost and must be replaced.

2. Pulley Removal

After the removal of the radiator and fan, if necessary, the second step that consists of removing the water pump pulley is started. To carry out this step, it is necessary to remove the fan belt, immobilize the pulley and, with a common or existing tool, remove the fastening element(s). Having in mind that, to carry out this step, the space available is very small, and the tool used is, many times, inadequate, there is the possibility of misaligning the water pump pulley and its screws and damaging it (by bending) or, even, cause damages to the pump.

3. Water Pump Removal

Finally, the third and last step consists of the water pump removal.

The water pump removal process described above is time consuming, expensive and, sometimes, causes damages to the elements involved in the removal, due to the use of inadequate tools within a space that is usually very small inside the vehicle's engine compartment. Additionally, in other systems involving pulleys, the process for removing them is similar to the one described in the second step, however, observed the particularities of each case.

Until this moment, a pulley that made possible the easy removal of an internal combustion engine component, such as the water pump, had not yet been developed. Neither, an easy, quick and cheap method for removing this pulley had been developed, which could cause few or no damage at all to the systems involved or its surrounding elements.

### OBJECTIVES OF THE INVENTION

The present invention has as first objective a pulley, particularly designed for use in an internal combustion engine, designed in such a way to make possible the easy removal of a component from an internal combustion engine, such as a water pump, without the need to partially disassemble the engine and without the risk of damaging it through the use of incorrect tools.

The present invention has as a second objective a method for the easy removal of the pulley designed above, without the need to partially disassemble the engine by means of a tool with pins or similar projecting elements, thus allowing easy access and avoiding damages to the systems involving the pulley.

The present invention has as a third objective to provide an internal combustion engine equipped with, at least, one pulley as described here.

### BRIEF DESCRIPTION OF THE INVENTION

The first objective of the present invention is achieved by a pulley, particularly for use in internal combustion engines, for the transmission of rotational movement produced by an engine crankshaft, which presents a substantially cylindrical shape and has at least one first main portion substantially circular and at least one opening for association to at least one substantially rotatable shaft, the first main portion comprising at least one first orifice to position a projecting tool element.

The second objective of the present invention is achieved by a method for removing a pulley, particularly a pulley as defined in the previous paragraph, comprising the following steps:

Step (i): positioning of at least one projecting tool element in the first orifice;

Step (ii): immobilization of the substantially rotatable shaft to which the pulley is associated; and

Step (iii): disassociation between the pulley and the substantially rotatable shaft.

The third objective of the present invention is achieved by an internal combustion engine that comprises at least one pulley, such as defined above.

The present invention presents, as advantages, the fact of devising a pulley that turns the engine maintenance services much easier, due to the reduction in maintenance time and steps, avoids the need for disassembling engine components, radiator, etc., and replacing cooling or lubricating fluids, reduces the possibility of pulley damages and misalignment, due to the means to apply the correct screw tightening torque, etc.

### BRIEF DESCRIPTION OF THE DRAWINGS

The present invention will be described below, with more details, by means of an example of execution represented in the drawings. The figures show:

FIG. 1—front view in perspective of an internal combustion engine equipped with the pulley object of the present invention.

FIG. 2—detailed view in perspective of the pulley object of the present invention, to which a fan is associated, being possible to observe the tools necessary for its removal.

FIG. 3—view in perspective of the pulley object of the present invention and of a tool devised for its removal.

FIG. 4—detailed view in perspective of the pulley object of the present invention, without the fan, being it possible to observe the tools necessary for its removal.

FIG. 5—cross section view of the pulley object of the present invention with the tool devised for its removal.

FIG. 6—front view of the pulley object of the present invention, associated to the water pump of an internal combustion engine.

FIG. 7—first view of the pulley shown in FIG. 6, to which a tool devised for its removal was associated.

FIG. 8—second view of the pulley shown in FIG. 6, to which a tool devised for its removal was associated.

### DETAILED DESCRIPTION OF THE FIGURES

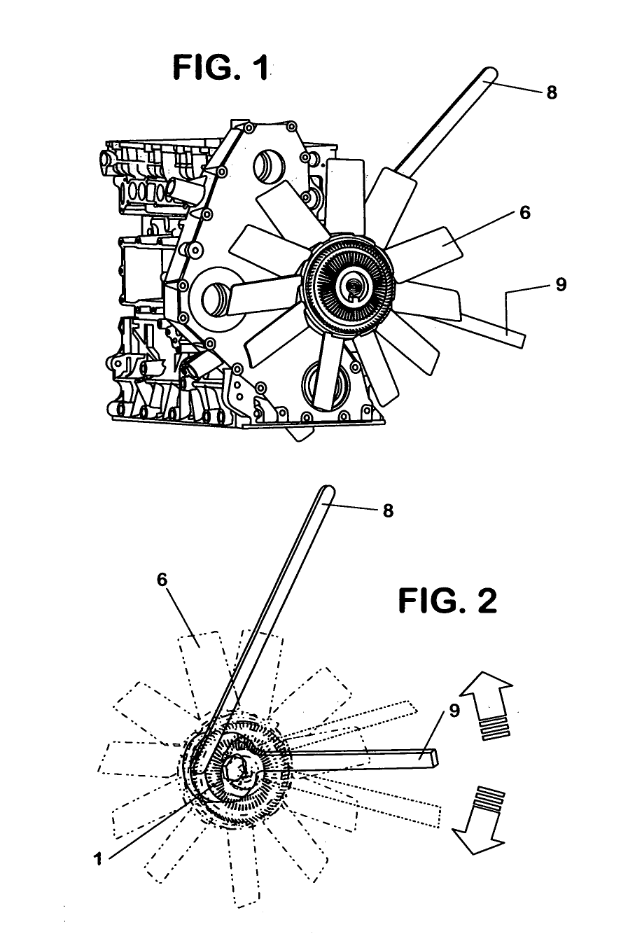

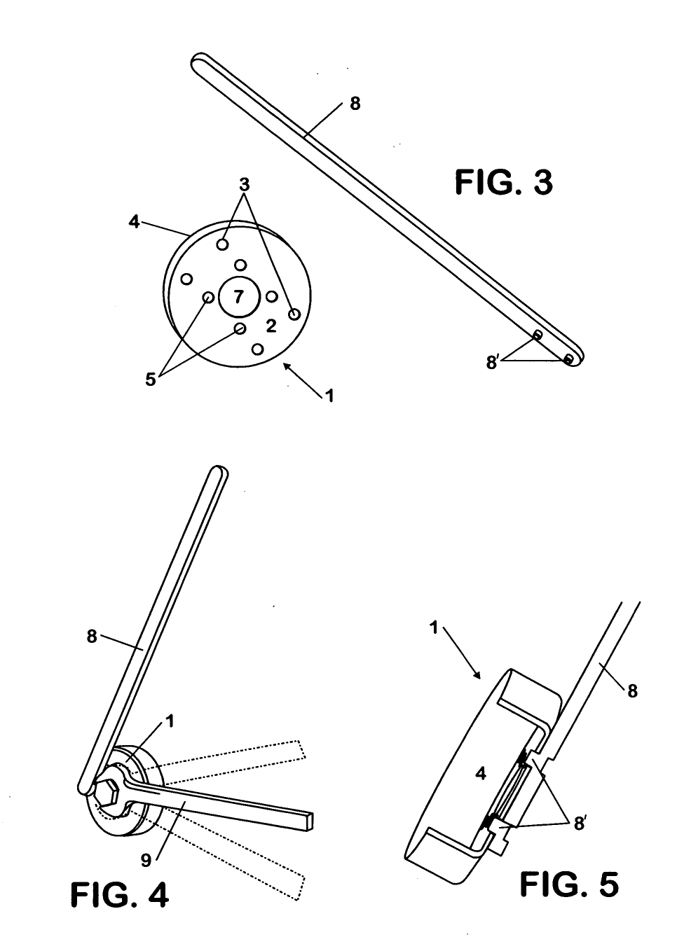

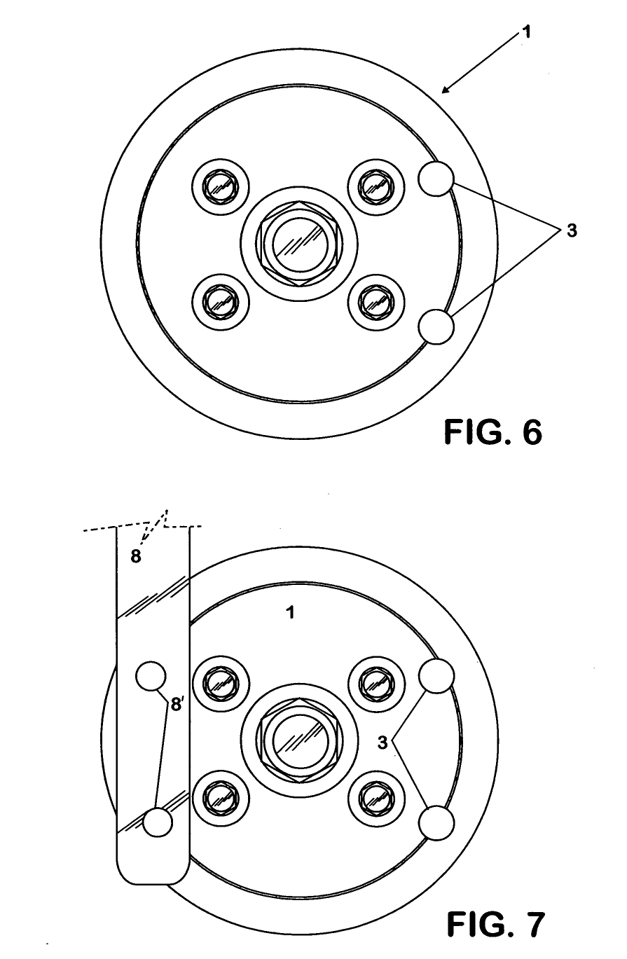

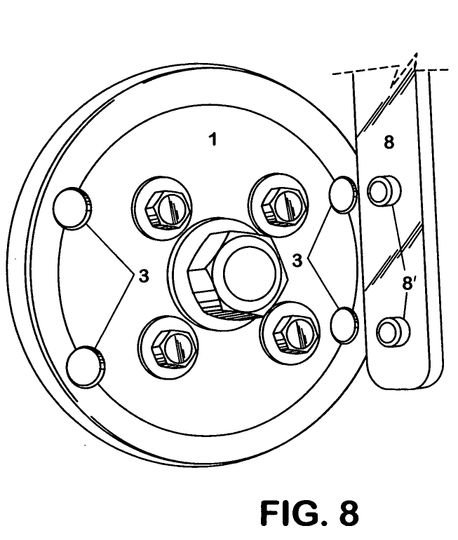

According to a preferred version and as can be seen in FIG. 1, the present invention refers to a pulley, particularly for use in an internal combustion engine for transmission of the rotational movement produced by an engine crankshaft, presenting a substantially cylindrical shape and having at least one first main portion 2 substantially circular and at least one opening 7 for association to at least one substantially rotatable shaft, which will be better described below. The first main portion 2 comprises at least one first orifice 3 for positioning of a projecting tool element.

Internal combustion engine is understood as any engine that provides circular movement, such as an engine operating according to the Otto cycle, a Diesel engine, a 2-stroke engine, a Wankel, or even any other type. Additionally, there would be no restrictions for the use of the pulley 1, now devised, in other types of motors, such as electric motors, for example, since this would be technically perfectly possible.

Whichever the engine, it shall have a rotating shaft, as for example a crankshaft (as in the Otto, Diesel, 2-stroke engines, etc.) that rotates driven by the explosion of an air-fuel mixture. In order to transfer the angular crankshaft movement to other shafts, gears, belts or chains are conventionally used, each one presenting advantages and disadvantages.

In case of using belts, there is a rotating pulley (usually a pulley associated to the crankshaft) and at least one rotatable pulley, associated to another component (which will be mentioned later). A belt built of polymeric material involves both pulleys and transmits the rotating pulley's angular movement to the rotatable pulley.

In the case of the chains, the situation is the same, being the only difference the fact that both pulleys present teeth-shaped projections (sprockets) that cooperate with the chain links.

So, in order to transmit the movement, pulley 1 should be associated to a rotatable shaft, whichever it is.

In a preferred manner, pulley 1, object of the present invention, is devised to be used in components which movement is desired, that is, components that cannot move individually. The main components to which pulley 1 can be associated are mentioned below:
Water pump,
Alternator,
Fuel injection pump,
Belt/chain tensioner,
Air conditioning compressor,
Power steering hydraulic pump,
Vacuum pump,
Camshaft,
Intermediate shaft,
Crankshaft,
Etc.

Please note that, although some preferred uses are mentioned, there is no restriction for pulley 1, as covered by the present invention, to be used in another components/equipment, if necessary or desirable.

Whichever the equipment where it is being used, and regardless of its particular configuration, the pulley 1 object of the present invention, presents a substantially cylindrical shape, that guarantees stability and dynamic balance when it rotates, and comprises a substantially circular first main portion 2 from which a second main portion projects 4, sided located, substantially cylindrical. Practically, the second portion corresponds to the pulley sidewall, and its surface is the path, that is, the place where the belt (not shown) touches the pulley 1. The belt used can be of any known type (trapezoidal, multi-V, toothed, etc.)

In case of using chain, a second main portion 4 presents a plurality of radial projections in the form of teeth (sprockets), which substantially cooperate with the drive chain (among its links). This second type of pulley, although covered by the protection scope of the attached claims, is not shown in the figures.

Additionally, pulley 1 comprises means for fastening to the rotatable shaft, what may belong to one or another of the previously listed components. Preferably, the fastening takes place by means of a concentric opening 7, but it is evident that any other solution can be used provided the results are practical. The only requirement is that the pulley has to be always concentric to this shaft and keeping full alignment, otherwise its rotation may bring insoluble vibrations that might even damage pulley 1 and the shaft.

Still in a preferred manner, pulley 1 comprises at least one second passing orifice 5 that fastens a component as, for example, at least one fan 6. In an even more preferred manner, the pulley comprises four-seconds orifices 5 positioned at equal distances from each other, two by two, so that a fan, attached to them, remains absolutely concentric to pulley 1. This situation can be seen in FIGS. 1 and 2. Evidently, it is possible to foresee other ways of fastening fan 6 to pulley 1, provided they are practical.

The great innovation of pulley 1 object of the present invention, regarding the other pulleys already known, lies in the existence of the already mentioned first orifice 3, which will make possible its easy locking with a specific first tool 8.

This first orifice 3 cooperates with at least one projection 8′ existing in the first tool (also called projecting tool element), in such a way that, when projection 8′ is inserted inside the orifice, it becomes impossible to move pulley 1 angularly in respect to tool 8. Therefore, its locking is made easier.

In a preferred manner, pulley 1 comprises four passing first orifices 3, substantially circular and substantially positioned concentrically among each other, equidistant and symmetrical, two by two. However, it is evident that pulley 1 can be provided with more than four orifices 3, or with only a single orifice with a substantially elongated longitudinal section (opening), for example, in the shape of a linear groove, which would make possible the positioning of two projections 8′ inside it. Equally, orifices 3 may be non passing, provided the thickness of the first main portion makes possible its existence and functionality. Additionally, the positioning of the first orifices or orifices 3 can be any, provided it is made in first main portion 2. Please note that it is very important to position the orifices in such a way that the dynamic balance of pulley 1 is not disturbed, thus avoiding potentially damaging vibrations when in high rotation.

Therefore, the quantity, shape and positioning of first orifices 3 may vary, provided they guarantee that first tool 8 and pulley 1 do not move, one in respect to the other, when projection or projections 8′ are inside of orifice or orifices 3.

The method to remove pulley 1, object of the present invention, is also a new and inventive invention and is protected by the attached claims.

Generally speaking, the method to remove the pulley here defined comprises the following steps:

Step (i): positioning of at least one projecting tool element 8′ on the first orifice 3;

Step (ii): immobilization of the substantially rotatable shaft to which pulley 1 is associated; and

Step (iii): disassociation between pulley 1 and the substantially rotatable shaft.

Step (i), more particularly, corresponds to the positioning of projecting tool element 8′ of the specific first tool 8 inside first orifice 3.

Step (ii), more particularly, corresponds to the immobilization of the substantially rotatable shaft by means of a second generic tool 9.

Step (iii), more particularly, is performed from the angular movement of one of the first or second tools 8,9 one in respect to the other.

Therefore, it is only necessary to insert the projection or projections 8′ inside of orifice or orifices 3 and, at the same time, immobilize the substantially rotatable shaft of the component to which pulley 1 is positioned, with the second generic tool 9 (as a nut wrench, for example). After that, one of the tools is angularly moved regarding the other, what will cause the loosening or disassociation of pulley 1 in respect to the shaft. This work is made much easier with pulley 1, object of the present invention, once the locking of the pulley is easily carried out by means of first specific tool 8.

First tool 8, by the way, is of very simple construction and corresponds, essentially, to a lever (cylindrical, flat, or of any other desired cross section) having one of its ends provided with projection or projections 8′.

Due to its thin shape, tool 8 can be easily positioned on pulley 1, without the need of disassembling engine components, radiator, etc., thus providing a great advantage during engine maintenance services, through reduction of time and maintenance steps, not requiring the replacement of cooling or lubricating fluids, reduction of the possibility of pulley damages and misalignment, due to the easy application of the correct tightening torque on the screws, etc.

Finally, an internal combustion engine equipped with at least one pulley 1, object of the present invention, is also a new and inventive invention, covered by the protection scope of the attached claims.

Since an example of a preferred construction was described, it shall be understood that the scope of the present invention covers other possible variations and it is exclusively limited by the contents of the attached claims, there included the possible equivalents.

I claim:

1. Pulley, particularly for use in an internal combustion engine, for the transmission of the rotational movement produced by an engine crankshaft, the pulley (1) presenting a shape substantially cylindrical and having at least one first main portion (2) substantially circular and at least one opening (7) for association to at least one substantially rotatable shaft, characterized in that that the first main portion (2) comprises at least one first orifice (3) to the position of a projecting tool element (8′).

2. Pulley according to claim 1, characterized in that that it comprises four first orifices (3) positioned substantially concentrically among each other, equidistant and symmetric two by two.

3. Pulley according to claim 1 or 2, characterized in that that it comprises four first passing orifices (3), substantially circular.

4. Pulley according to a claim 1, 2 or 3, characterized in that that it comprises additionally at least a second passing orifice (5) to fasten at least one fan (6).

5. Pulley according to any of claims 1 to 4, characterized in that that it comprises at least a second main portion (4), sided located, substantially cylindrical and cooperating with at least one belt of polymeric material.

6. Pulley according to any of claims 1 to 4, characterized in that that it comprises at least a second main portion (4), sided located, featuring many radial projections substantially cooperating with one drive chain.

7. Method for removing a pulley, particularly a pulley as defined in claims 1 to 6 above, characterized in that that it comprises the following steps:
step (i): positioning of at least one projecting tool element (8′) on the first orifice (3);
step (ii): immobilization of the substantially rotatable shaft to which the pulley (1) is associated; and
step (iii): disassociation between pulley (1) and the substantially rotatable shaft.

8. Method according to claim 7, characterized in that that step (i) corresponds to the positioning of the projecting tool element (8′) of a first specific tool (8) inside the first orifice (3).

9. Method according to claim 7, characterized in that that step (ii) corresponds to the immobilization of the substantially rotatable shaft by means of a second generic tool (9).

10. Method according to claim 7, characterized in that that step (iii) is performed from the angular movement of one of the first or second tools (8,9) in respect to the other.

11. Internal combustion engine, characterized in that that it comprises at least one pulley as defined in claims 1 to 6.
